(19) United States
(12) Patent Application Publication
(10) Pub. No.: US 2026/0202657 A1
(43) Pub. Date: Jul. 16, 2026

(54) OPTICAL AIMING DEVICE

(71) Applicant: Asia Optical Co., Inc., Taichung (TW)

(72) Inventor: Yung-Chin Lin, Taichung (TW)

(21) Appl. No.: 19/444,313

(22) Filed: Jan. 9, 2026

(30) Foreign Application Priority Data
Jan. 15, 2025 (TW) 114101656

(51) Int. Cl. G02B 23/10; G02B 1/11; G02B 23/14; G02B 23/16

(52) U.S. Cl. CPC G02B 23/105; G02B 1/11; G02B 23/14; G02B 23/16

(57) ABSTRACT

An optical aiming device includes a light source module, a base and a reflector. The light source module includes a light source and a substrate for carrying the light source. The base includes a light exiting structure, a first end portion and a second end portion. The light source module is disposed on the base with the light source directed at the first end portion. The reflector is disposed on the first end portion. Illuminating light emitted from the light source is corresponded to a range of an illumination angle. The illuminating light in the range of the illumination angle is reflected by the reflector to form reflected light. The light exiting structure includes a through hole. A part of the illuminating light which is not reflected by the reflector is directed at the through hole, passes through the through hole, and leaves the base.

### BACKGROUND OF THE INVENTION

### Field of the Invention

The invention relates to a technical field of an optical aiming device for generating illumination light, and more particularly to an optical aiming device capable of eliminating additional bright areas of the pattern caused by light reflection from an element surface.

### Description of the Related Art

FIGS. 1 and 2 depict a conventional optical aiming device A used for a sight, wherein the optical aiming device A has a base A1. The base A1 has a reflector A2 and an optical lens A3 respectively disposed at opposite ends thereof. A light source module L is disposed inside the base A1. The light source module L has a light source L1 directed at the reflector A2. Light emitted from the light source L1 is reflected by the reflector A2 and passes through the optical lens A3 to form a pattern for the user to view.

In the conventional optical aiming device A, the inner surfaces of the base A1 may reflect light, and the substrate L2 for carrying the light source L1 of the light source module L and the packaging structure for housing the light source L1 may also reflect light. Specifically, light may be reflected by the inner surface of the base A1, the surface of the substrate L1 of the light source module L, or the packaging structure of the light source L1. The reflected light is then reflected by the reflector A2 and passes through the optical lens A3 to produce patterns which are different from the pattern directly formed by the light emitted from the light source L1 and reflected by the reflector A2 and the optical lens A3. In addition, the light reflected by the inner surface of the base A1, the surface of the substrate L2 of the light source module L, or the packaging structure of the light source L1 may form multiple overlapping patterns. As a possible result, the pattern produced by the light source L1 fails to be clearly presented that may confuse the user and affect the sighting operation.

### BRIEF SUMMARY OF THE INVENTION

The invention provides an optical aiming device. The optical aiming device in accordance with an exemplary embodiment of the invention includes a light source module, a base and a reflector. The light source module includes a light source and a substrate for carrying the light source. The base includes a light exiting structure, a first end portion and a second end portion, wherein the first end portion and the second end portion are disposed opposite to each other, and the light source module is disposed on the base with the light source of the light source module directed at the first end portion. The reflector is disposed on the first end portion and has a first optical axis. Illuminating light emitted from the light source is corresponded to a range of an illumination angle. The illuminating light in the range of the illumination angle is reflected by the reflector to form reflected light. The light exiting structure includes a through hole, a part of the illuminating light which is not reflected by the reflector is directed at the through hole, and the part of the illuminating light passes through the through hole and leaves the base. An axis of the through hole is not parallel to an optical axis of the reflected light.

In another exemplary embodiment, the base further includes a bottom plate disposed thereon and corresponded to the light exiting structure, and the part of the illuminating light passes through the through hole of the light exiting structure and reaches a portion of the bottom plate disposed between the first end portion and the second end portion.

In yet another exemplary embodiment, the base further includes a first reflective surface. The light exiting structure is disposed on the first reflective surface. The axis of the through hole is perpendicular to the optical axis of the reflected light.

In another exemplary embodiment, the base further includes a first light absorption structure and a second reflective surface. The first light absorption structure is disposed on the first reflective surface and/or the second reflective surface. The second reflective surface is disposed adjacent to or opposite to the first reflective surface. The first light absorption structure includes a black roughened layer.

In yet another exemplary embodiment, the optical aiming device further includes an optical lens disposed at the second end portion. The optical lens has a second optical axis, and the reflected light travels in parallel to the second optical axis and passes through the optical lens. The reflector is a curved reflector and has a focal point, and the light source of the light source module is located at the focal point of the reflector.

In another exemplary embodiment, the light source module further includes a second light absorption structure. The substrate includes a flexible circuit board. The flexible circuit board includes a reflective outer surface. The second light absorption structure is disposed on the reflective outer surface. The illuminating light outside the range of the illumination angle is directly or indirectly projected to the reflective outer surface and is absorbed by the second light absorption structure.

In yet another exemplary embodiment, the light source includes a packaging structure and a light emitting portion. The packaging structure includes a light emitting surface disposed adjacent to the light emitting portion, and a third light reflection suppression structure disposed on the light emitting surface. The third light reflection suppression structure includes a third light absorption structure. The third light absorption structure includes a black adhesive layer. The second light absorption structure includes another black adhesive layer.

In another exemplary embodiment, an optical aiming device includes a light source module, a base and a reflector. The light source module includes a light source and a substrate for carrying the light source. The base includes a first end portion and a second end portion, wherein the first end portion and the second end portion are disposed opposite to each other, and the light source module is disposed on the base with the light source of the light source module directed at the first end portion. The reflector is disposed on the first end portion and has a first optical axis. Illuminating light emitted from the light source is corresponded to a range of an illumination angle. The illuminating light in the range of the illumination angle is reflected by the reflector to form reflected light. The light source module further includes a second light absorption structure. The substrate includes a flexible circuit board. The flexible circuit board includes a reflective outer surface. The second light absorption structure is disposed on the reflective outer surface. The illuminating light outside the range of the illumination angle is directly or indirectly projected to the reflective outer surface and is absorbed by the second light absorption structure.

In yet another exemplary embodiment, the base includes a light exiting structure. The light exiting structure includes a through hole. A part of the illuminating light which is not reflected by the reflector is directed at the through hole. The part of the illuminating light passes through the through hole and leaves the base.

In another exemplary embodiment, the base further includes a bottom plate disposed thereon and corresponded to the light exiting structure, and the part of the illuminating light passes through the through hole of the light exiting structure and reaches a portion of the bottom plate disposed between the first end portion and the second end portion.

In yet another exemplary embodiment, the base further includes a first reflective surface, and the light exiting structure is disposed on the first reflective surface.

In another exemplary embodiment, the base further includes a first light absorption structure and a second reflective surface. The first light absorption structure is disposed on the first reflective surface and/or the second reflective surface. The second reflective surface is disposed adjacent to or opposite to the first reflective surface. The first light absorption structure includes a black roughened layer.

In yet another exemplary embodiment, the optical aiming device further includes an optical lens disposed at the second end portion. The optical lens has a second optical axis, and the reflected light travels in parallel to the second optical axis and passes through the optical lens. The reflector is a curved reflector and has a focal point, and the light source of the light source module is located at the focal point of the reflector.

In another exemplary embodiment, the light source includes a packaging structure and a light emitting portion. The packaging structure includes a light emitting surface disposed adjacent to the light emitting portion, and a third light reflection suppression structure disposed on the light emitting surface. The third light reflection suppression structure includes a third light absorption structure. The third light absorption structure includes a black adhesive layer. The second light absorption structure includes another black adhesive layer.

In yet another exemplary embodiment, the optical aiming device further includes an optical lens disposed at the second end portion. The optical lens has a second optical axis, and the reflected light travels in parallel to the second optical axis and passes through the optical lens. The reflector is a curved reflector and has a focal point, and the light source of the light source module is located at the focal point of the reflector. An axis of the through hole is not parallel to an optical axis of the reflected light.

In another exemplary embodiment, the axis of the through hole is perpendicular to the optical axis of the reflected light.

In yet another exemplary embodiment, an optical aiming device includes a light source module, a base and a reflector. The light source module includes a light source and a substrate for carrying the light source. The base includes a light exiting structure, a first end portion and a second end portion, wherein the first end portion and the second end portion are disposed opposite to each other, and the light source module is disposed on the base with the light source of the light source module directed at the first end portion. The reflector is disposed on the first end portion and having a first optical axis. Illuminating light emitted from the light source is corresponded to a range of an illumination angle. The illuminating light in the range of the illumination angle is reflected by the reflector to form reflected light. The light exiting structure includes a through hole, a part of the illuminating light which is not reflected by the reflector is directed at the through hole, and the part of the illuminating light passes through the through hole and leaves the base. The base further includes a first reflective surface, and the light exiting structure is disposed on the first reflective surface.

In another exemplary embodiment, the base further includes a first light absorption structure and a second reflective surface. The first light absorption structure is disposed on the first reflective surface and/or the second reflective surface. The second reflective surface is disposed adjacent to or opposite to the first reflective surface. The first light absorption structure includes a black roughened layer. An axis of the through hole is not parallel to an optical axis of the reflected light.

In yet another exemplary embodiment, the optical aiming device further includes an optical lens disposed at the second end portion. The optical lens has a second optical axis, and the reflected light travels in parallel to the second optical axis and passes through the optical lens. The reflector is a curved reflector and has a focal point, and the light source of the light source module is located at the focal point of the reflector. The axis of the through hole is perpendicular to the optical axis of the reflected light.

In another exemplary embodiment, the light source module further includes a second light absorption structure. The substrate includes a flexible circuit board. The flexible circuit board includes a reflective outer surface. The second light absorption structure is disposed on the reflective outer surface. The illuminating light outside the range of the illumination angle is directly or indirectly projected to the reflective outer surface and is absorbed by the second light absorption structure. The light source includes a packaging structure and a light emitting portion. The packaging structure includes a light emitting surface disposed adjacent to the light emitting portion, and a third light reflection suppression structure disposed on the light emitting surface. The third light reflection suppression structure includes a third light absorption structure. The third light absorption structure includes a black adhesive layer, and the second light absorption structure includes another black adhesive layer.

In the optical aiming device of the invention, a first light reflection suppression structure is provided on the reflective inner surface of the base, a second light reflection suppression structure is provided on the reflective outer surface of the substrate of the light source module, and a third light reflection suppression structure is provided on the light emitting surface of the packaging structure of the light source. Thus, even if the illumination light emitted from the light source can reach the reflective inner surface of the base, the reflective outer surface of the substrate of the light source module, and/or the light emitting surface of the packaging structure of the light source, the resulting reflected light has a relatively low intensity or the illumination light is completely absorbed. The user will only see the pattern formed by the illumination light emitted by the light source directly reflected by the reflector and through the optical lens, without seeing any other patterns or multiple overlapping patterns, and the pattern formed directly by the illumination light of the light source can be clearly presented.

### BRIEF DESCRIPTION OF THE DRAWINGS

FIG. 1 depicts a cross section of a conventional optical aiming device of a sight.

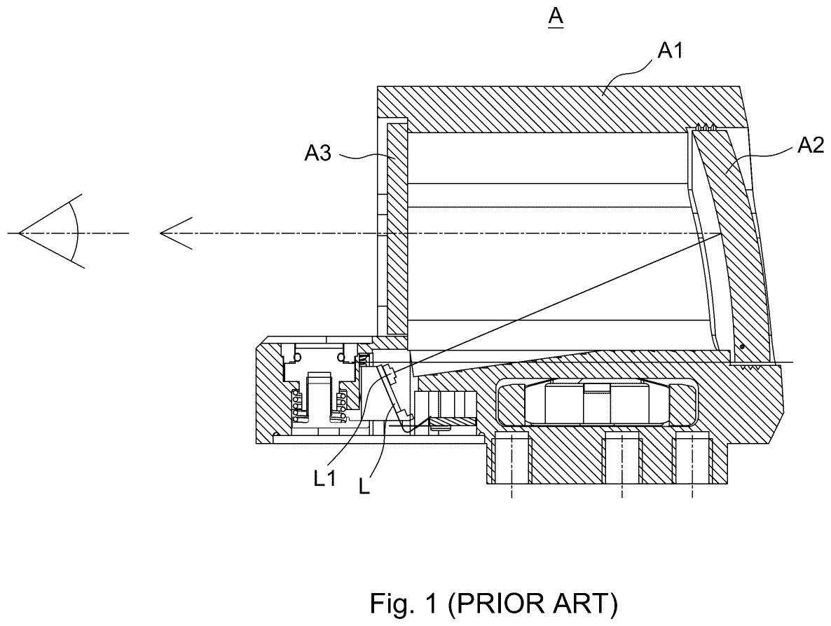

FIG. 2 is a schematic view of the light source module of the optical aiming device of FIG. 1.

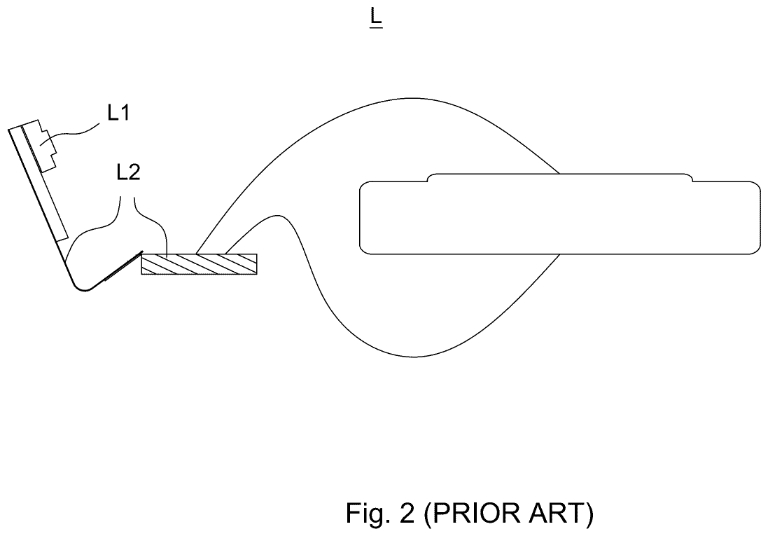

FIG. 3 depicts a cross section of an optical aiming device of a sight in accordance with an embodiment of the invention.

FIG. 4 is a perspective exploded view of the optical aiming device of FIG. 3.

FIG. 5 is another perspective exploded view of the optical aiming device of FIG. 3 observed at another angle.

FIG. 6 is a schematic view of the light source module of the optical aiming device of FIG. 3.

FIG. 7 is a schematic view of a substrate of the light source module and a packaging structure of the light source of FIG. 6.

### DETAILED DESCRIPTION OF THE INVENTION

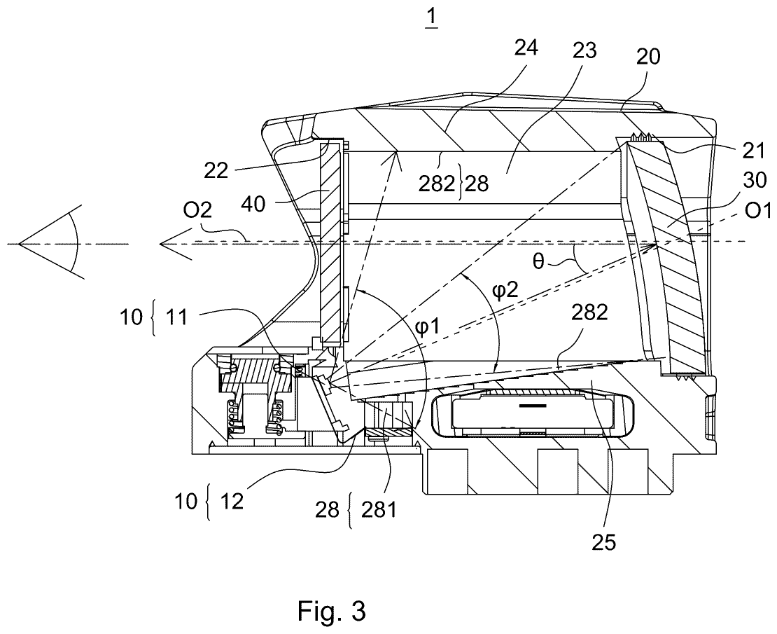

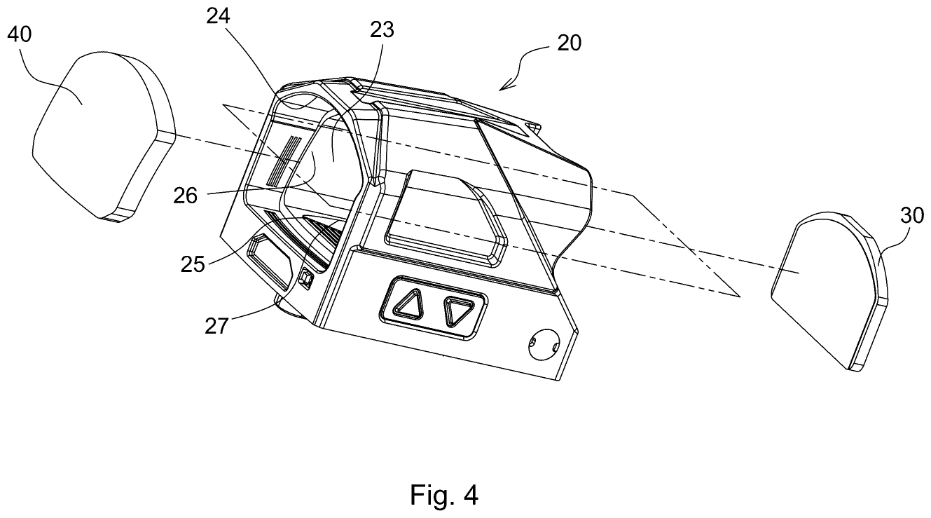

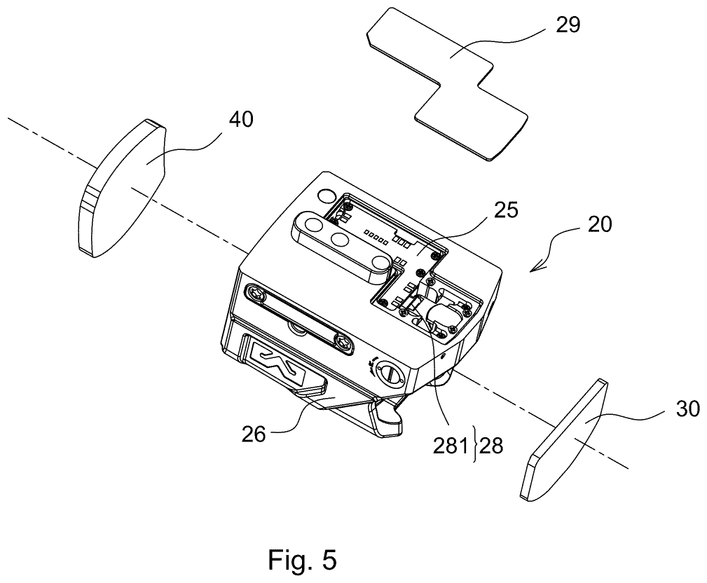

FIGS. 3-6 depict an optical aiming device of a sight in accordance with an embodiment of the invention, wherein the optical aiming device 1 includes a light source module 10, a base 20, a reflector 30 and an optical lens 40. The light source module 10 is disposed in the base 20. The reflector 30 and the optical lens 40 are respectively disposed at opposite ends of the base 20. Light emitted from the light source module 10 is reflected by the reflector 30 to form images on the optical lens 40. That is, a predetermined sighting pattern is formed on the optical lens 40. Light emitted from a distant target object passes through the reflector 30 and the optical lens 40. Then, the user is able to aim the sighting pattern at the distant target object. The reflector 30 has a surface disposed near the light source module 10 and a coating may be provided on the surface to reflect light of a specific wavelength, so that the light emitted from the target object can pass through the reflector 30, while the illumination light emitted from the light source module 10 is reflected by the reflector 30.

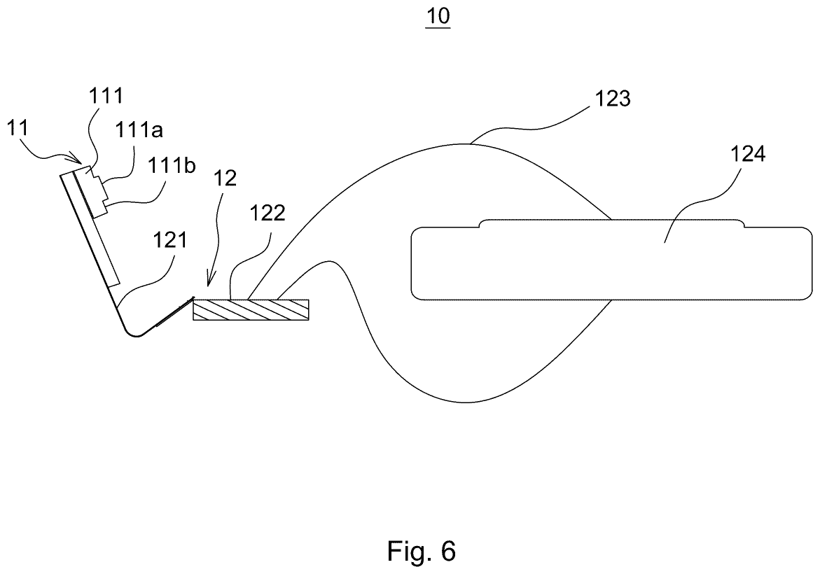

The light source module 10 includes a light source 11 and a substrate 12 for carrying the light source 11. As shown in FIG. 6, the substrate 12 includes a flexible circuit board 121 and a rigid circuit board 122. The light source 11 is disposed on the flexible circuit board 121. The flexible circuit board 121 is connected to the rigid circuit board 122. The rigid circuit board 122 is connected to a power source 124 through wires 123. The light source 11 has a packaging structure 111 which includes a light emitting portion 111a and a light emitting surface 111b. The light emitting portion 111a is disposed on the light emitting surface 111b. The light emitting portion 111a is provided with, for example, light-emitting diodes (LEDs) or resonant cavity light-emitting diodes (RCLEDs).

As shown in FIGS. 3, 4 and 5, the base 20 includes a first end portion 21, a second end portion 22, and an optical space 23. The first end portion 21 and the second end portion 22 are disposed opposite to each other. The first end portion 21 and the second end portion 22 are disposed at opposite sides of the base 20. Specifically, the base 20 includes a top wall 24, a bottom wall 25 and two side walls 26 and 27. The top wall 24, the bottom wall 25 and the side walls 26 and 27 are connected to each other to form the optical space 23. The light source module 10 is disposed on the bottom wall 25 of the optical space 23. The reflector 30 is disposed at the first end portion 21. The optical lens 40 is disposed at the second end portion 22. The reflector 30 has a first optical axis O1. The optical lens 40 has a second optical axis O2. The second optical axis O2 extends along the axial direction of the base 20. The first optical axis O1 has an inclination angle θ relative to the second optical axis O2. In this embodiment, the reflector 30 is a curved reflector. The reflector 30 has a focal point. The light source 11 of the light source module 10 is located at the focal point of the reflector 30, and the light emitting portion 111a of the light source 11 faces the reflector 30 disposed at the first end portion 21.

The illumination light emitted from the light emitting portion 111a of the light source 11 has a beam angle φ1. The illumination light, within a range of an illumination angle φ2, is able to directly reach the reflector 30 and is reflected by the reflector 30 to form a reflected light. The reflected light passes through the optical lens 40 along the second optical axis O2.

The illuminating light outside the range of the illumination angle φ2 (i.e., the illuminating light not directly reflected by the reflector) may reach the top wall 24, the bottom wall 25, and the side walls 26, 27 of the base 20, is reflected by the top wall 24, the bottom wall 25, and the side walls 26, 27, and passes through the optical lens 40 to produce pattern (images), wherein the patterns are not the sighting pattern and may be overlapped. That is, the top wall 24, the bottom wall 25, and the side walls 26, 27 of the base 20 constitute reflective surfaces (a first reflective surface and a second reflective surface) capable of reflecting the illuminating light. In order to suppress the reflection of the illuminating light on the reflective surfaces, the base 20 further includes a first light reflection suppression structure 28 disposed on each reflective surface.

The first light reflection suppression structure 28 includes a light exiting structure 281 and a first light absorption structure 282. The light exiting structure 281 allows the illuminating light to pass through the base 20, thereby causing the illuminating light to leave the optical space 23 without reflection. The first light absorption structure 282 absorbs the illuminating light, thereby reducing the intensity of the reflected light reflected by each reflective surface. Therefore, the intensity of the reflected light, as compared to the intensity of the illuminating light within the range of the illumination angle φ2, is relatively weak and is not sufficient to produce a visible pattern.

In this embodiment, the light exiting structure 281 is disposed on the reflective surface (the first reflective surface) of the bottom wall 25 of the base 20. The light exiting structure 281 is a structure with multiple through holes or a grid, allowing the illuminating light to directly enter, pass through and leave the optical space 23. In this embodiment, axes of the through holes are not parallel to an optical axis of the reflected light wherein the reflected light is obtained from reflection of the illumination light by the reflector 30 as described above, and the optical axis of the reflected light and the second optical axis O2 of the optical lens 40 coincide as shown in FIG. 3. Specifically, the axes of the through holes are perpendicular to the optical axis of the reflected light. Further, the light exiting structure 281 is formed on the bottom wall 25 of the base 20, and the illuminating light passes through the light exiting structure 281 and then reaches the bottom plate 29 disposed below the base 20. However, the invention is not limited thereto. In another embodiment, the light exiting structure 281 further includes a transparent window structure formed of glass or acrylic material, which has both light emission function and waterproofing function.

In this embodiment, the first light absorption structure 282 is a black roughened layer formed on each reflective surface (the first reflective surface and the second reflective surface). The roughened layer is formed by appropriately processing a surface, for example, by sandblasting to roughen each reflective inner surface. In this way, the first light absorption structure 282 can both scatter and absorb the illuminating light. In this embodiment, the first light absorption structure 282 is disposed on the top wall 24, the bottom wall 25, and the side walls 26 and 27 of the base 20.

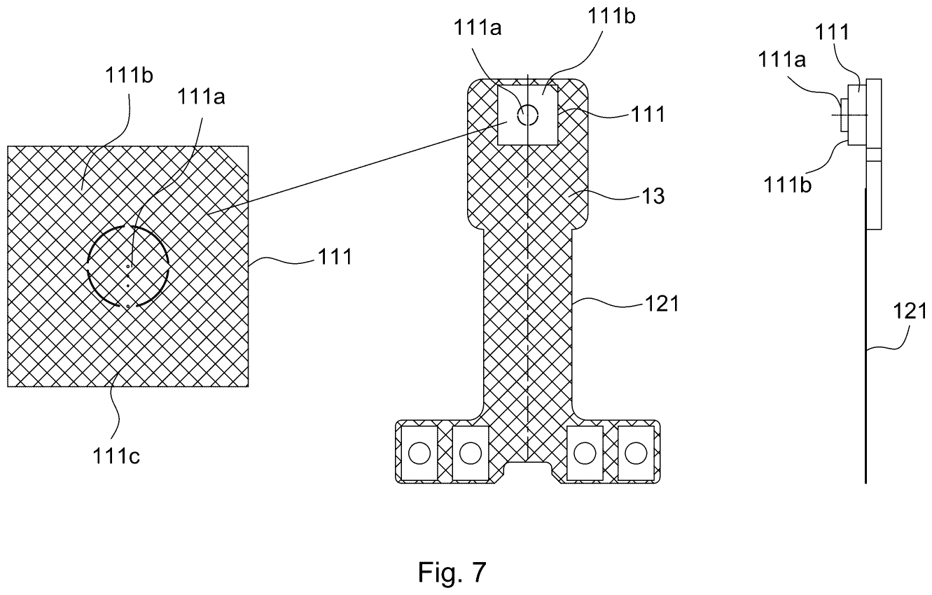

As shown in FIG. 7, since the outer surface of the substrate 12 of the light source module 10 is also a reflective outer surface which reflects the illuminating light for generating a pattern on the optical lens 40, the light source module 10 further includes a second light reflection suppression structure 13. The second light reflection suppression structure 13 is disposed on the reflective outer surface of the substrate 12. Illuminating light outside the range of the illumination angle φ2 is directly or indirectly projected to the substrate 12, and the reflection of the illuminating light is suppressed by the second light reflection suppression structure 13. The second light reflection suppression structure 13 includes a second light absorption structure, which can be, for example, a black adhesive layer. The second light absorption structure is formed by coating black adhesive on the reflective outer surface of the substrate 12 to absorb the illuminating light and reduce the intensity of the reflected light reflected by the reflective outer surface. Therefore, the intensity of the reflected light, as compared to the intensity of the illuminating light within the range of the illumination angle φ2, is relatively weak and is not sufficient to produce a visible pattern. In this embodiment, the second light reflection suppression structure 13 is formed on the flexible circuit board 121 of the substrate 12.

The light emitting surface 111b of the packaging structure 111 of the light source 11 can also reflect the illuminating light to generate a pattern on the optical lens 40. Therefore, the packaging structure 111 further includes a third light reflection suppression structure 111c. In this embodiment, the third light reflection suppression structure 111c includes a third light absorption structure. The third light absorption structure can be, for example, a black adhesive layer, with black adhesive material coated on the light emitting surface 111b to absorb the illuminating light and reduce the intensity of the reflected light reflected by the reflective outer surface. Therefore, the intensity of the reflected light, as compared to the intensity of the illuminating light within the range of the illumination angle φ2, is relatively weak and is not sufficient to produce a visible pattern.

In the optical aiming device of the invention, a first light reflection suppression structure is provided on the reflective inner surface of the base, a second light reflection suppression structure is provided on the reflective outer surface of the substrate of the light source module, and a third light reflection suppression structure is provided on the light emitting surface of the packaging structure of the light source. Thus, even if the illumination light emitted from the light source can reach the reflective inner surface of the base, the reflective outer surface of the substrate of the light source module, and/or the light emitting surface of the packaging structure of the light source, the resulting reflected light has a relatively low intensity or the illumination light is completely absorbed. The user will only see the pattern formed by the illumination light emitted by the light source directly reflected by the reflector and through the optical lens, without seeing any other patterns or multiple overlapping patterns, and the pattern formed directly by the illumination light of the light source can be clearly presented.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention.

What is claimed is:

1. An optical aiming device, comprising:
a light source module comprising a light source and a substrate for carrying the light source;
a base comprising a light exiting structure, a first end portion and a second end portion, wherein the first end portion and the second end portion are disposed opposite to each other, and the light source module is disposed on the base with the light source of the light source module directed at the first end portion; and
a reflector disposed on the first end portion and having a first optical axis;
wherein illuminating light emitted from the light source is corresponded to a range of an illumination angle;
wherein the illuminating light in the range of the illumination angle is reflected by the reflector to form reflected light;
wherein the light exiting structure comprises a through hole, a part of the illuminating light which is not reflected by the reflector is directed at the through hole, and the part of the illuminating light passes through the through hole and leaves the base;
wherein an axis of the through hole is not parallel to an optical axis of the reflected light.

2. The optical aiming device as claimed in claim 1, wherein the base further comprises a bottom plate disposed thereon and corresponded to the light exiting structure, and the part of the illuminating light passes through the through hole of the light exiting structure and reaches a portion of the bottom plate disposed between the first end portion and the second end portion.

3. The optical aiming device as claimed in claim 1, wherein:
the base further comprises a first reflective surface;
the light exiting structure is disposed on the first reflective surface;
the axis of the through hole is perpendicular to the optical axis of the reflected light.

4. The optical aiming device as claimed in claim 3, wherein:
the base further comprises a first light absorption structure and a second reflective surface;
the first light absorption structure is disposed on the first reflective surface and/or the second reflective surface;
the second reflective surface is disposed adjacent to or opposite to the first reflective surface;
the first light absorption structure comprises a black roughened layer.

5. The optical aiming device as claimed in claim 3, further comprising:
an optical lens disposed at the second end portion;
wherein the optical lens has a second optical axis, and the reflected light travels in parallel to the second optical axis and passes through the optical lens;
wherein the reflector is a curved reflector and has a focal point, and the light source of the light source module is located at the focal point of the reflector.

6. The optical aiming device as claimed in claim 1, wherein:
the light source module further comprises a second light absorption structure;
the substrate comprises a flexible circuit board;
the flexible circuit board comprises a reflective outer surface;
the second light absorption structure is disposed on the reflective outer surface;
the illuminating light outside the range of the illumination angle is directly or indirectly projected to the reflective outer surface and is absorbed by the second light absorption structure.

7. The optical aiming device as claimed in claim 6, wherein:
the light source comprises a packaging structure and a light emitting portion;
the packaging structure comprises a light emitting surface disposed adjacent to the light emitting portion, and a third light reflection suppression structure disposed on the light emitting surface;
the third light reflection suppression structure comprises a third light absorption structure;
the third light absorption structure comprises a black adhesive layer;
the second light absorption structure comprises another black adhesive layer.

8. An optical aiming device, comprising:
a light source module comprising a light source and a substrate for carrying the light source;
a base comprising a first end portion and a second end portion, wherein the first end portion and the second end portion are disposed opposite to each other, and the light source module is disposed on the base with the light source of the light source module directed at the first end portion; and
a reflector disposed on the first end portion and having a first optical axis;
wherein illuminating light emitted from the light source is corresponded to a range of an illumination angle;
wherein the illuminating light in the range of the illumination angle is reflected by the reflector to form reflected light;
wherein the light source module further comprises a second light absorption structure;
wherein the substrate comprises a flexible circuit board;
wherein the flexible circuit board comprises a reflective outer surface;
wherein the second light absorption structure is disposed on the reflective outer surface;
wherein the illuminating light outside the range of the illumination angle is directly or indirectly projected to the reflective outer surface and is absorbed by the second light absorption structure.

9. The optical aiming device as claimed in claim 8, wherein:
the base comprises a light exiting structure;
the light exiting structure comprises a through hole;
a part of the illuminating light which is not reflected by the reflector is directed at the through hole;
the part of the illuminating light passes through the through hole and leaves the base.

10. The optical aiming device as claimed in claim 9, wherein the base further comprises a bottom plate disposed thereon and corresponded to the light exiting structure, and the part of the illuminating light passes through the through hole of the light exiting structure and reaches a portion of the bottom plate disposed between the first end portion and the second end portion.

11. The optical aiming device as claimed in claim 9, wherein the base further comprises a first reflective surface, and the light exiting structure is disposed on the first reflective surface.

12. The optical aiming device as claimed in claim 11, wherein:
the base further comprises a first light absorption structure and a second reflective surface;
the first light absorption structure is disposed on the first reflective surface and/or the second reflective surface;
the second reflective surface is disposed adjacent to or opposite to the first reflective surface;
the first light absorption structure comprises a black roughened layer.

13. The optical aiming device as claimed in claim 12, further comprising:
an optical lens disposed at the second end portion;
wherein the optical lens has a second optical axis, and the reflected light travels in parallel to the second optical axis and passes through the optical lens;
wherein the reflector is a curved reflector and has a focal point, and the light source of the light source module is located at the focal point of the reflector.

14. The optical aiming device as claimed in claim 13, wherein:
the light source comprises a packaging structure and a light emitting portion;
the packaging structure comprises a light emitting surface disposed adjacent to the light emitting portion, and a third light reflection suppression structure disposed on the light emitting surface;
the third light reflection suppression structure comprises a third light absorption structure;
the third light absorption structure comprises a black adhesive layer;
the second light absorption structure comprises another black adhesive layer.

15. The optical aiming device as claimed in claim 9, further comprising:
an optical lens disposed at the second end portion;
wherein the optical lens has a second optical axis, and the reflected light travels in parallel to the second optical axis and passes through the optical lens;
wherein the reflector is a curved reflector and has a focal point, and the light source of the light source module is located at the focal point of the reflector;
wherein an axis of the through hole is not parallel to an optical axis of the reflected light.

16. The optical aiming device as claimed in claim 15, wherein the axis of the through hole is perpendicular to the optical axis of the reflected light.

17. An optical aiming device, comprising:
a light source module comprising a light source and a substrate for carrying the light source;
a base comprising a light exiting structure, a first end portion and a second end portion, wherein the first end portion and the second end portion are disposed opposite to each other, and the light source module is disposed on the base with the light source of the light source module directed at the first end portion; and
a reflector disposed on the first end portion and having a first optical axis;
wherein illuminating light emitted from the light source is corresponded to a range of an illumination angle;
wherein the illuminating light in the range of the illumination angle is reflected by the reflector to form reflected light;
wherein the light exiting structure comprises a through hole, a part of the illuminating light which is not reflected by the reflector is directed at the through hole, and the part of the illuminating light passes through the through hole and leaves the base;
wherein the base further comprises a first reflective surface, and the light exiting structure is disposed on the first reflective surface.

18. The optical aiming device as claimed in claim 17, wherein:
the base further comprises a first light absorption structure and a second reflective surface;
the first light absorption structure is disposed on the first reflective surface and/or the second reflective surface;
the second reflective surface is disposed adjacent to or opposite to the first reflective surface;
the first light absorption structure comprises a black roughened layer;
an axis of the through hole is not parallel to an optical axis of the reflected light.

19. The optical aiming device as claimed in claim 17, further comprising:
an optical lens disposed at the second end portion;
wherein the optical lens has a second optical axis, and the reflected light travels in parallel to the second optical axis and passes through the optical lens;
wherein the reflector is a curved reflector and has a focal point, and the light source of the light source module is located at the focal point of the reflector;
wherein the axis of the through hole is perpendicular to the optical axis of the reflected light.

20. The optical aiming device as claimed in claim 17, wherein:
the light source module further comprises a second light absorption structure;
the substrate comprises a flexible circuit board;
the flexible circuit board comprises a reflective outer surface;
the second light absorption structure is disposed on the reflective outer surface;
the illuminating light outside the range of the illumination angle is directly or indirectly projected to the reflective outer surface and is absorbed by the second light absorption structure;
the light source comprises a packaging structure and a light emitting portion;
the packaging structure comprises a light emitting surface disposed adjacent to the light emitting portion, and a third light reflection suppression structure disposed on the light emitting surface;
the third light reflection suppression structure comprises a third light absorption structure;
the third light absorption structure comprises a black adhesive layer, and the second light absorption structure comprises another black adhesive layer.
